(19) United States
(12) Patent Application Publication
(10) Pub. No.: US 2016/0310841 A1
(43) Pub. Date: Oct. 27, 2016

(54) CONTROLLER FOR VIDEO GAME CONSOLE

(71) Applicant: EINAR OFFERDAHL III, KENNEWICK, WA (US)

(72) Inventor: EINAR OFFERDAHL III, KENNEWICK, WA (US)

(21) Appl. No.: 14/694,113

(22) Filed: Apr. 23, 2015

(51) Int. Cl. A63F 13/24

(52) U.S. Cl. CPC A63F 13/24

(57) ABSTRACT

An improved controller (10) for a game console that is intended to be held by a user in both hands in the same manner as a conventional controller (1), which has controls on the front operable by the thumbs (2), (3), (4), (5), and has up to eight controls combined within an interchangeable member (11) located on the back in positions to be operated by the middle fingers of a user, mounted by use of a distended base (12) or recessed base (13)

### BACKGROUND OF THE INVENTION

The present invention relates to video game consoles, in particular to hand held controllers for video games.

Conventional controllers for most game consoles are intended to be held and operated by the user using both hands. A conventional controller will generally comprise a hard outer case with a plurality of controls mounted about the controller. Typically the controls include buttons, analogue sticks, bumpers, and triggers. An example of a conventional controller is shown in FIG. 1.

As can be seen in FIG. 1, all of the controls are mounted on the front and top edge of the controller 1, Specifically, there are left and right analogue thumb sticks 2,3 which normally control movement and are intended to be operated by the user's left and right thumb respectively. There are four buttons 4, located on a front right portion of the controller 1 which normally control additional actions and are intended to be operated by the user's left and right thumb. There is a direction pad 5 located on the lower portion of the front left of the controller 1. The direction pad 5 is intended to be operated by the user's left thumb, typically either as an alternative to the left thumb stick 2 or to provide additional actions. There is a left trigger 6, a right trigger 7, a left bumper 8, and a right bumper 9 located on the top edge of the controller 1. The left and right triggers 6, 7 are typically operated by the user's index fingers. The left and right bumpers 8, 9 may also be operated by the user's index fingers.

The only way to operate the four buttons 4 is for the user to remove his or her right thumb from the right thumb stick 3. This takes time and, in some games, can cause loss of control. This is a particular problem in games where the right thumb stick 3 is used for aiming. A similar problem may arise in games where the direction pad 5 provides additional actions and the user has to remove his or her thumb from the left thumb stick 2 in order to operate the direction pad 5.

Humans hand sizes, finger lengths, and finger dexterity vary greatly from one human to the next. The button location of a conventional controller 1 are typically located in the some location and same arrangement, despite greatly varying properties of human hands.

Some users use the conventional controller 1 as part of normal daily activities. A conventional controller 1 may also cause its user to suffer from Repetitive Motion Disorder, or RMD. As defined by the National Institute of Neurological Disorders and Stroke, as Repetitive motion disorders (RMDs) area family of muscular conditions that result from repeated motions performed in the course of normal work or daily activities. RMDs include carpal tunnel syndrome, bursitis, tendonitis, epicondylitis, ganglion cyst, tenosynovitis, and trigger finger. RMDs are caused by too many uninterrupted repetitions of an activity or motion, unnatural or awkward motions such as twisting the arm or wrist, overexertion, incorrect posture, or muscle fatigue. RMDs occur most commonly in the hands, wrists, elbows, and shoulders, but can also happen in the neck, back, hips, knees, feet, legs, and ankles.

Businesses in the video game console industry perform modification of conventional controllers. A high percentage of sales of modified controllers occur by mail order business conducted through the Internet. Due to the mail order business, consumes are not allowed to try products prior to purchasing products. Many consumers choose to play video games using an uncomfortable conventional modified controller rather than incurring the expense and inconvenience of returning their purchase to the mail order company.

In light of the above, there is a need for an improved controller which removes the need for a user to remove his or her thumb from the left or right thumb stick 2, 3 in order to operate additional actions controlled by the four buttons 4 and/or the direction pad 5.

In addition to the need to allow users to have his or her thumb remain on left or right thumb stick 2, 3, there is also a need for an improved controller that allows for periodic changing of the position of buttons. Since some RMD causes include unnatural or akward motions and incorrect positions, an improved controller with changeable button position could help alleviate RMD symptoms.

In addition to the needs above, there is also a need for a method to reduce the burdens of cost and inconvenience associated with customers trialing products by mail order.

### SUMMARY OF THE INVENTION

The present invention provides a hand held controller for a video game console having a hard outer case and a plurality of controls located on the front and top edge of the controller. The controller is shaped to be held in both hands of the user such that the user's thumbs are positioned to operate controls located on the front of the controller and the user's index fingers are positioned to operate controls located on the top edge of the controller. The controller further includes one or more additional controls located on the back of the controller in a position to be operated by the user's other fingers. The controller further includes interchangeable control members that may be removed or installed using common household tools.

In one embodiment, each additional control is combined into an interchangeable broad member which is inherently resilient and flexible such that it can be displaced by a user to activate control function.

Preferably, the interchangeable broad member is mounted upon a distended mount located on the case of the controller. In one embodiment, the interchangeable broad member is mounted within a recessed mount located in the case of the controller,

Preferably, the interchangeable broad member comprises an outermost surface which is disposed in close proximity to the outermost surface of the controller such that the user's finger may be received in said respective distension or recess.

Preferably, each interchangeable broad member has a thickness less than 10 mm thick, more preferably less than 5 mm thick, and most desirably between 0 mm and 2 mm thick,

Preferably, there are more than two but less than eight additional controls which are included in a single interchangeable broad member.

Optionally, a portion of the interchangeable broad member includes a switch mechanism disposed within the interchangeable broad member, such that displacement of the interchangeable broad member activates the switch mechanism.

Optionally, a switch mechanism is disposed between the interchangeable broad member and an outer surface of the controller.

The controller of the present invention may be very similar to controllers according to the prior art. In particular, the outer case of the controller and the type, number and positioning of the controls located on the front and top edge of the controller may be the same as a controller according to the prior art, as described above and as illustrated in the figures.

The controller of the present invention is particularly advantageous over controllers according to the prior art as it comprises two or more additional interchangeable controls located on the back of the controller. in a position to be operated by any fingers or a user. The additional controls may either replicate the functions of one or more of the controls located on the front or top edge of the controller or provide additional functionality.

In a preferred embodiment of the invention the additional controls replicate the function of a control located on the front of the controller. This means that a user does not need to remove his or her thumb from one of the thumb sticks in order to operate the buttons and/or direction pad located on the front of the controller and can instead perform the function by manipulating an additional control located on the back of the controller with a finger.

Alternatively, the additional controls may provide additional functionality in that they do not replicate the function of controls located on the front or top of the controller but may perform different functions. In this manner a controller according to the present invention pay provide more functions than prior art controllers.

Preferably, the controls located on the back of the controller are interchangeable levers. Suitable interchangeable levers may be formed integrally with the outer case of the controller or may be substantially separate from the outer case. This may be done in any manner apparent to the person skilled in the art. However, it is to be appreciated that the additional controls may comprise any other control suitable for use by a hand held controller.

Advantageously, if the additional controls are paddle levers, they will be formed such that they are substantially vertically aligned with respect to the controller. This may allow the most ergonomically efficient activation of the paddle levers by any fingers of the user.

Further features and advantages of the present invention will be apparent from the specific embodiment illustrated in the drawings and discussed below

### BRIEF DESCRIPTION OF THE DRAWINGS

FIG. 1 is a schematic illustration of the front of a conventional game controller according to the prior art.

FIGS. 2, 3, 4, 5, and 6 are schematic illustrations of the back of a game controller according to the present invention.

FIG. 7 is a schematic illustration of the back of a game controller according to the present invention as held and operated by a user.

### DETAILED DESCRIPTION OF THE INVENTION

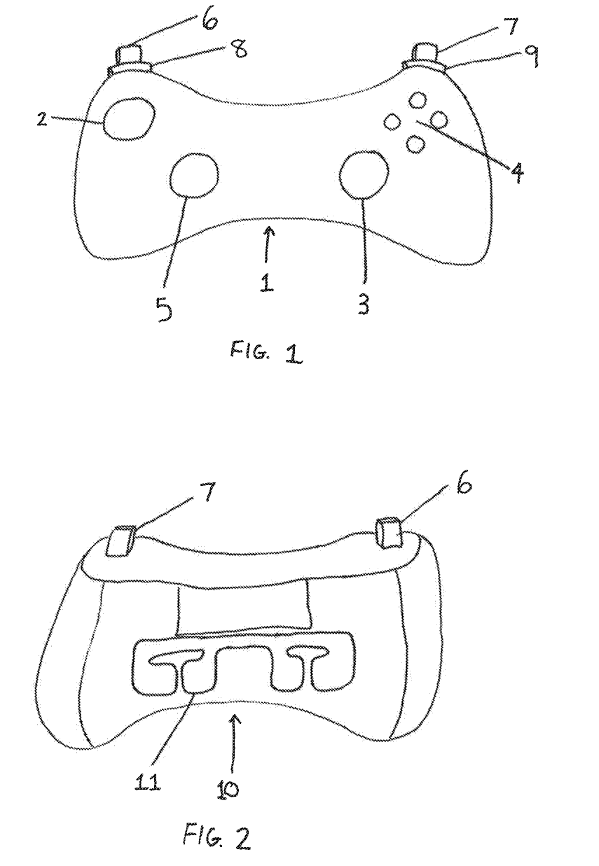

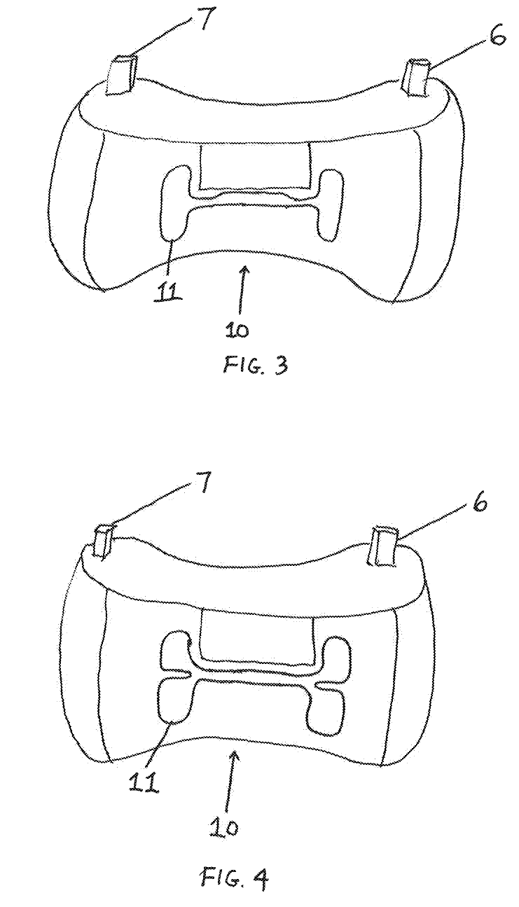

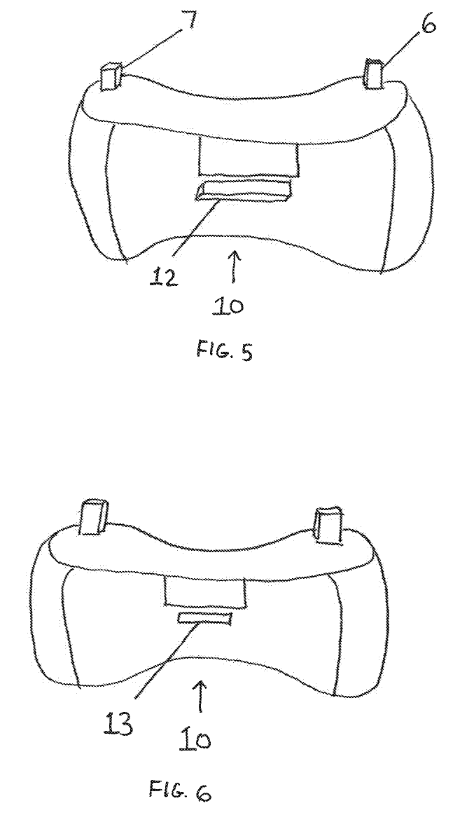

The particular embodiment described below and illustrated by FIGS. 2, 3, 4, 5, 6 and 7 serves to further illustrate the invention, to provide those of ordinary skill in the art with a complete disclosure and description of the devices claimed herein, and is not intended to limit the scope of the invention. For example, the additional controls are described below as a single interchangeable member but the term “control” as used in the claims, unless otherwise made clear in the claim, refers as well as other controls such as buttons, analogue control sticks, bumpers, and triggers.

The game controller 10 according to the present invention is illustrated in FIGS. 2, 3, 4, 5, 6 and 7. The front of the game controller 10 of FIGS. 2, 3, 4, 5, 6 and 7 is the same as a conventional controller 1, as illustrated in FIG. 1 and as discussed above. Therefore, where appropriate the same reference numerals have been used to indicate the features of the controller according to the present invention 10 that are identical to the features of a conventional controller 1.

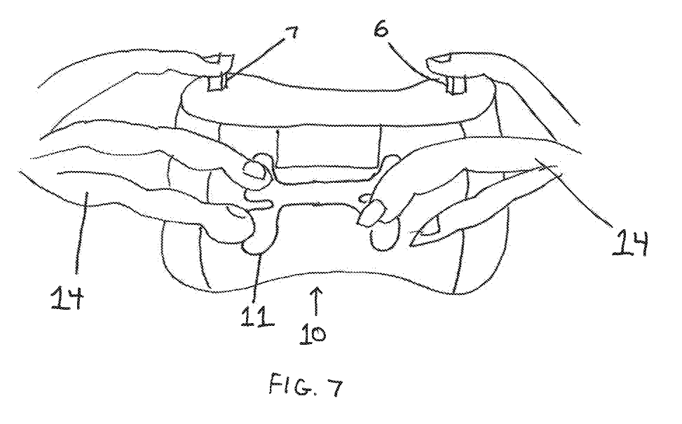

Game controller 10 differs from the conventional controller 1 in that it additionally comprises an interchangeable broad member 11 on the back of the controller. The interchangeable member 11 is vertically orientated with respect to the controller 10 and is positioned to be operated by the fingers of a user 14, as shown in FIG. 7.

In one embodiment a distended mounting base 12 is installed upon the back case of the controller.

In one embodiment a recessed mounting base 13 is installed within the back case of the controller.

In one embodiment the interchangeable member 11 is formed from a thin semi-flexible material such as fiberglass, copper-clad fiberglass, or plastics, Preferably, the interchangeable member 11 are less than 10 mm thick, but may be less than 5 mm thick, and more preferably are 2 mm thick or less.

The interchangeable member 11 is inherently resilient, which means that it returns to an unbiased position when not under load. A user may displace or depress areas of the interchangeable member 11 by engaging an outer surface thereof; such displacement causes the interchangeable member 11 one of multiple switch mechanisms mounted upon or within the body of the interchangeable member 11 itself. The interchangeable member 11 is mounted upon a distended mount 12 or into a recessed mount 13 installed upon or into the case of the controller 10, and is disposed in close proximity to the outer surface of the controller body. In this way a use may engage different areas of the interchangeable member 11 with the tips of the fingers without compromising the user's ergonomic hold of the controller 10. While the example shows the interchangeable member 11 engaged by middle fingers, they could be engaged by any fingers. The index fingers may also engage trigger style controls mounted on the top edge of the controller 10 while the thumbs may be used to activate controls on the front of the controller 10.

The interchangeable member 11 is broad in shape. In alternative embodiments interchangeable member 11 are shaped in various patterns shown in FIGS. 2, 3, and 4 to accommodate different human hand characteristics. These broad and variable shapes allow the user to ergonomically and comfortably engage various areas of the interchangeable member 11 with any finger, reducing effects of RMD.

In one embodiment, the interchangeable member 11 replicates the functions of more than two but less than eight of the four buttons 4 located on the front of the controller 10 and thereby allow a user to operate the functions of the relevant buttons using his or her middle fingers 12, without the need to remove either of his or her thumbs from the left or right thumb stick 2, 3. In alternative embodiments the interchangeable member 11 may activate a new function not activated by a control on the front or top edge of the controller 10.

It is envisaged that the interchangeable member 11 could be fitted to an existing controller 10 by means of a mounting base 12, 13. In such embodiments, the mounting base 12, 13 would be mounted on the outer surface of the controller body by means of a mechanical fixing such as a screw or bolt or alternatively bonded or welded to the controller body by adhesive epoxy or other suitable means. The interchangeable member 11 would be mounted on the mounting base 12,13 by means of a mechanical fixing such as a screw or bolt or alternatively press-fit plastic header or other suitable interchangeable means by use of household common tools. A switch mechanism would be mounted within the interchangeable member in vertical registry with a portion of the interchangeable member itself. A portion of the switch mechanism may extend through the interchangeable member body and be disposed in close proximity or in contact with the outermost surface of the controller 10.

In alternative embodiments it is envisaged that the interchangeable member 11 would be integrally formed with the controller body, the interchangeable member 11 being configured to be resilient and flexible such that it can be depressed by a user to activate a switch mechanism. This could be achieved by moulding the controller body to have included within it a distended mounting base 12 or recessed mounting base 13 for attachment of the interchangeable member 11. It will be recognized that as used herein, directional references such as “top”, “bottom”, “front”, “back”, “end”, “side”, “inner”, “outer”, “upper”, and “lower” do not limit the respective features to such orientation, but merely serve to distinguish these features from one another.

Modifications and variations of the present invention will be apparent to those skilled in the art from the forgoing detailed description. All modifications are variations are intended to be encompassed by the following claims. All publications, patents, and patent applications cited herein are hereby incorporated by reference in their entirety.

1. A hand held controller for a game console comprising:
an outer case comprising a front, a back, a top edge, and a bottom edge, wherein the back of the controller is opposite the front of the controller and the top edge is opposite the bottom edge; and
a front control located on the front of the controller;
wherein the controller is shaped to be held in the hand of a user such that the user's thumb is positioned to operate the front controller; and
in one embodiment of the invention, more than two but less than eight back controls, each back control being located on the back of the controller with all back controls combined into an interchangeable broad member that is inherently resilient and flexible; and
in another embodiment of the invention, more than two but less than eight back controls, each back control being located on the back of the controller with all back controls combined into a two broad members that are inherently resilient and flexible.

2. The controller of claim 1, further having a top edge control located on the top edge of the controller and wherein the controller is shaped such that the user's index finger is positioned to operate the top edge control.

3. The controller of claim 1, wherein each of the back controls is positioned to be operated by any finger of a user with the exception of the thumb.

4. The controller of claim 1, in one embodiment wherein the broad member is mounted upon a distended mount located on the case of the controller, in another embodiment wherein the broad member is mounted into a recessed mount located in the case of the controller.

5. The controller of claim 1, wherein the broad member comprises an outermost surface which is disposed in close proximity to the outermost surface of the controller such that a user's finger may be received upon said respective distended mount.

6. The controller of claim 1, wherein each broad member has a thickness between about 0 mm and 2 mm.

7. The controller of claim 1, wherein each broad member has a thickness between about 1 mm and 5 mm.

8. The controller of claim 1, wherein each broad member has a thickness between about 1 mm and 10 mm.

9. The controller of claim 1, wherein each broad member is detachable from the base.

10. The controller of claim 1, wherein a portion of at least one of the back controls is in registry with a switch mechanism disposed upon or within the broad member, such that displacement of at least one back control activates the switch mechanism.

11. The controller of claim 1, wherein a switch mechanism is disposed between the broad member and an outer surface of the back of the controller.

12. The controller of claim 2, wherein at least one of the back controls replicates the function of one or more of the top edge control and the front control.

13. The controller of claim 2, wherein at least one of the back controls has functions in addition to the top edge control and the front edge control.

14. The controller of claim 1, where in at least one of the back controls is a paddle lever.

15. The controller of claim 1, wherein at least one of the back controls is substantially parallel to the front of the controller.

16. The controller of claim 1, wherein at least one of the back controls is formed as an integral part of the outer case.

17. The controller of claim 1, wherein at least one of the back controls is formed separate from the outer case of the controller.

18. The controller of claim 1, wherein the top edge is substantially perpendicular to the front.

19. A hand held controller for a game console comprising:
an outer case comprising a front, a back, a top edge, and a bottom edge, wherein the back of the controller is opposite the front of the controller and the top edge is opposite the bottom edge;
a front control located on the front of the controller, wherein the controller is shaped to be held in the hand of a user such that the user's thumb it positioned to operate the front control; and
in one embodiment of the invention, more than two but less than eight back controls, each back control being located on the back of the controller with all back controls combined into a single broad member that is inherently resilient and flexible; and
in another embodiment of the invention, more than two but less than eight back controls, each back control being located on the back of the controller with all back controls combined into a two broad members that are inherently resilient and flexible.
